(19) United States
(12) Patent Application Publication
(10) Pub. No.: US 2022/0354335 A1
(43) Pub. Date: Nov. 10, 2022

(54) WASHING APPLIANCE

(71) Applicant: Electrolux Appliances Aktiebolag, Stockholm (SE)

(72) Inventors: Anders Haegermarck, Trångsund (SE); Eduardo Martinez, Stockholm (SE)

(73) Assignee: Electrolux Appliances Aktiebolag, Stockholm (SE)

(21) Appl. No.: 17/624,486

(22) PCT Filed: Jul. 5, 2019
(86) PCT No.: PCT/EP2019/068093

§ 371 Date: Jan. 3, 2022

(51) Int. Cl. A47L 15/42

(52) U.S. Cl. CPC A47L 15/4219; A47L 15/4291

(57) ABSTRACT

A washing appliance having a washing compartment, a water inlet tank configured to accommodate water for use in a wash cycle in the washing compartment, and a water inlet conduit configured to supply water to the water inlet tank. The washing appliance further comprises a drain conduit configured to conduct washing liquid from the washing compartment and a heat exchanger configured to exchange heat between the drain conduit and the water inlet conduit. Moreover, the washing appliance comprises a heat pump circuit comprising a condenser and an evaporator, wherein the condenser is configured to heat the washing compartment.

### TECHNICAL FIELD

The present disclosure relates to washing appliance, such as a dishwasher, comprising a heat pump circuit.

### BACKGROUND

Washing is a method of cleaning, usually with water and often some kind of soap or detergent. Washing appliances, such as washing machines and dishwashers are available on the market. A washing machine is an apparatus for washing of clothing or other cloth items, such as bed sheets, and the like. A dishwasher is an apparatus for washing items such as dishware, cutlery, and the like. A dishwasher comprises a washing compartment where the items are positioned, usually in racks, and dishwashers typically comprise one or more spray arms spraying washing liquid, e.g. a mixture of water and detergent, onto the items to clean them. The washing liquid is collected in a sump at a bottom of the washing compartment. A circulation pump of the dishwasher is fluidly connected to the sump and pumps washing liquid from the sump to the spray arms during a wash cycle. In order to improve the washing efficiency and the final washing result, the washing liquid is heated to a high temperature, typically between 45 and 75° C., by one or more heating elements of the washing appliance.

There are many requirements on today's washing appliances. Examples of such requirements are that a washing appliance is expected to wash items with a good washing result while environmental concerns require an efficient use of energy during a washing session. Furthermore, generally, on today's consumer market, it is an advantage if products, such as washing appliances, have conditions and/or characteristics suitable for being manufactured and assembled in a cost-efficient manner.

Attempts have been made to reduce the energy consumption of washing appliances by introducing heat recovery systems, heat pumps, and the like. However, many of these systems and arrangements are complex, expensive, require a lot of space in the washing appliance, and cause an increased risk of clogging of pipes and conduits of the washing appliance.

### SUMMARY

It is an object of the present invention to overcome, or at least alleviate, at least some of the above-mentioned problems and drawbacks.

According to an aspect of the invention, the object is achieved by a washing appliance comprising a washing compartment, a water inlet tank configured to accommodate water for use in a wash cycle in the washing compartment, and a water inlet conduit configured to supply water to the water inlet tank. The washing appliance further comprises a drain conduit configured to conduct washing liquid from the washing compartment and a heat exchanger configured to exchange heat between the drain conduit and the water inlet conduit. The washing appliance further comprises a heat pump circuit comprising a condenser and an evaporator, wherein the condenser is configured to heat the washing compartment.

Since the washing appliance comprises the heat exchanger and the heat pump circuit, the inputted energy required for heating water in wash cycles of the washing appliance is substantially reduced. Moreover, conditions are provided for shortening the time required for washing cycles of the washing appliance. Accordingly, a washing appliance is provided capable of operating using significantly less inputted energy with reduced operational times.

Moreover, since the washing appliance comprises the heat exchanger configured to exchange heat between the drain conduit and the water inlet conduit, the operation time of the heat pump circuit can be reduced and a smaller compressor in the heat pump circuit can be used, than would be the case otherwise. As a further result thereof, the available space in the washing appliance can be utilized in an efficient manner and conditions are provided for the washing compartment to occupy a great proportion of the total inner volume of the washing appliance.

Moreover, a washing appliance is provided capable of transferring heat from liquid in the drain conduit to water in the water inlet conduit without the use of a complicated system, and in a manner allowing the use of a simple low-cost water inlet tank, as compared to washing appliances with other types of heat recovery systems. As a result, a washing appliance is provided having conditions and characteristics suitable for being manufactured and assembled in a cost-efficient manner.

Furthermore, since the water inlet tank and the heat exchanger are separate units, the available space in the washing appliance can be utilized in a further efficient manner.

Moreover, since the water inlet tank and the heat exchanger are separate units and the water inlet tank is configured to accommodate water for use in a wash cycle, a flexible washing appliance is provided having conditions for filling the water inlet tank, and transferring heat to water flowing through the water inlet conduit, when wanted. As a further result thereof, the energy efficiency of the washing appliance can be further improved.

Accordingly, a washing appliance is provided overcoming, or at least alleviating, at least some of the above-mentioned problems and drawbacks. As a result, the above-mentioned object is achieved.

Optionally, the washing appliance comprises a media container, and wherein the evaporator is configured to cool a media in the media container. Thereby, a washing appliance is provided capable of using the heat of the media in the media container for heating the washing compartment. Thereby, the need for a fan is circumvented blowing cold air into a room in which the washing appliance is positioned. As a further result thereof, unwanted cooling of a floor surface of the room is circumvented. Moreover, some prior art heat pump circuits utilize drain water as a heat source for the evaporator. However, such solutions risk getting clogged by particles in the drain water and by build up of fat on surfaces of the of the evaporator. Thus, in relation to such solutions, a more reliable washing appliance is provided.

Optionally, the evaporator is configured to cool the media in the media container such that the media changes phase from liquid to solid. Thereby, the heat collecting capacity of the media in the media container is significantly increased thus providing conditions for a further heating of the washing compartment.

Optionally, the evaporator comprises fins extending into the media container. Thereby, the heat transferring capacity between the media in the media container and working fluid of the heat pump circuit is significantly increased. Moreover, a more uniform solidification process is provided in the media container.

Optionally, the media comprises water. Thereby, a washing appliance is provided utilizing heat of a low cost, and environmentally friendly, media having high specific heat capacity for heating the washing compartment.

Optionally, the washing appliance further comprises a circulation circuit configured to circulate water from the water inlet tank through the media container. Thereby, a washing appliance is provided capable of heating the media in the media container using the heat of the water in the water inlet tank and consequently also cooling the water in the inlet water tank. As a further result thereof, an improved drying performance of the washing appliance can be provided in an energy efficient manner. This because the cold water obtained from the circulation of water from the water inlet tank through the media container can be utilized to improve and accelerate a condensation process of water in the washing appliance.

Optionally, the washing appliance comprises an inlet valve configured to control flow of water in the water inlet conduit and a drain pump configured to pump washing liquid from the washing compartment via the drain conduit, and wherein the washing appliance comprises a control arrangement configured to selectively control an opening state of the inlet valve based on an operational state of the drain pump. Thereby, the energy efficiency of the washing appliance can be further improved due to improved heat transfer from liquid in the drain conduit to water in the water inlet conduit.

Optionally, the control arrangement is configured to estimate a flow rate of liquid flowing through the drain conduit, and wherein the control arrangement is configured to control the opening state of the valve based on the estimated flow rate of liquid flowing through the drain conduit. Thereby, the energy efficiency of the washing appliance can be further improved by improving the heat transfer from liquid in the drain conduit to water in the water inlet conduit.

Optionally, the control arrangement is configured to estimate the flow rate of liquid flowing through the drain conduit by monitoring the torque of the drain pump. Thereby, the flow rate of liquid flowing through the drain conduit is estimated in a simple and efficient manner without the need for additional sensors. Thus, a washing appliance is provided having conditions and characteristics suitable for being manufactured and assembled in a cost-efficient manner.

Optionally, the control arrangement is configured to open the valve when it is estimated that liquid is flowing through the drain conduit, and/or when it is estimated that liquid recently has flowed through the drain conduit. Thereby, the energy efficiency of the washing appliance is further improved because the heat transfer from liquid in the drain conduit to water in the water inlet conduit is further improved.

Optionally, the control arrangement is further configured to control operation of the drain pump. Thereby, a still more flexible washing appliance is provided, with improved controllability, thus providing conditions for a further improved energy efficiency of the washing appliance by improving the heat transfer from liquid in the drain conduit to water in the water inlet conduit.

Optionally, the control arrangement is configured to control the drain pump to operate in cycles. Thereby, the energy efficiency of the washing appliance is further improved because more time is available for heat transfer from liquid in the drain conduit to water in the water inlet conduit. Furthermore, the pulsating flow of the liquid in the drain conduit may contribute to a turbulent flow in the second passage of the heat exchanger which increases heat transfer to water in the first passage of the heat exchanger.

Optionally, the cycles comprise operation intervals and standstill intervals between the operation intervals. Thereby, the energy efficiency of the washing appliance is further improved because more time is available for heat transfer from liquid in the drain conduit to water in the water inlet conduit. Furthermore, the pulsating flow of the liquid in the drain conduit may contribute to a turbulent flow in the second passage of the heat exchanger which increases heat transfer to water in the first passage of the heat exchanger.

Optionally, a length of the standstill intervals is within the range of 0.5 seconds to 7 seconds, such as within the range of 1 second to 3 seconds. Thereby, an improved energy efficiency is provided while the time required for drainage is not significantly increased.

Optionally, a length of the operation intervals is within the range of 0.5 seconds to 3 seconds, such as within the range of 0.7 seconds to 1.5 seconds. Thereby, an improved energy efficiency is provided while the time required for drainage is not significantly increased.

Optionally, the condenser is arranged in heat exchanging contact with a wall of the washing compartment. Thereby, a simple arrangement is provided while an efficient transfer of heat is provided from the condenser to the washing compartment.

Optionally, the circulation circuit comprises a circulation pump, and wherein the washing appliance comprises a control arrangement configured to activate the circulation pump in a drying phase of the washing appliance. Thereby, in a drying phase of the washing appliance, the circulation pump will circulate water from the water inlet tank through the media container. As a result thereof, an improved drying performance is provided in an energy efficient manner and less time is thereby required for the drying phase. This because the cold water obtained from the media container improves and accelerates the condensation process of water in the drying phase of the washing appliance.

Optionally, the water inlet tank is arranged in heat exchanging contact with a wall of the washing compartment. Thereby, a further improved drying performance is provided in an energy efficient manner and even less time is thereby required for the drying phase. This because the cold water in the water inlet tank cools the wall of the washing compartment in an efficient manner, which improves and accelerates the condensation process of water on the wall of the washing compartment.

Optionally, the heat exchanger comprises a first passage configured to conduct water flowing through the water inlet conduit and a second passage configured to conduct liquid flowing through the drain conduit. Thereby, a simple and efficient heat exchanger is provided.

Optionally, the heat exchanger comprises a wall separating the first and second passages, and wherein the wall is corrugated. Thereby, the heat transfer from liquid in the drain conduit to water in the water inlet conduit is further improved. This because the corrugated wall increases the surface area between the first and second passages and because the corrugated wall may contribute to a turbulent flow of liquid through the first and second passages. In this manner, the energy efficiency of the washing appliance is further improved.

Optionally, the heat exchanger comprises a vortex generator at an inlet of the second passage. Thereby, the heat transfer from liquid in the drain conduit to water in the water inlet conduit is further improved. This because the vortex generator will generate a vortex in the liquid flowing into the second passage of the heat exchanger, which creates a more turbulent flow through the second passage. In this manner, the energy efficiency of the washing appliance is further improved.

Optionally, the first passage is arranged to conduct water in a first flow direction and the second passage is arranged to conduct liquid in a second flow direction, and wherein the second flow direction is opposite to the first flow direction. Thereby, the energy efficiency of the washing appliance is further improved because the heat transfer from liquid in the drain conduit to water in the water inlet conduit is further improved.

Optionally, the first and second passages are coaxially arranged. Thereby, a simple and efficient heat exchanger is provided having conditions and characteristics suitable for being manufactured and assembled in a cost-efficient manner. Furthermore, a heat exchanger is provided requiring little space in the washing appliance. In this manner, the heat exchanger will have a low impact on the space available for other components of the washing appliance, such as the washing compartment of the washing appliance. Moreover, due to these features, the risk of a clogged heat exchanger is reduced.

Optionally, the first passage is coaxially arranged around the second passage. Thereby, heat can be transferred from liquid in the drain conduit to water in the water inlet conduit in an efficient manner, while the risk for clogging in the second passage is kept low, for example with particles in the drain liquid.

Optionally, the washing appliance is a dishwasher. Thereby, a dishwasher is provided capable of operating using significantly less inputted energy with reduced operational times.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 schematically illustrates a washing appliance, according to some embodiments.

### DETAILED DESCRIPTION

Aspects of the present invention will now be described more fully. Like numbers refer to like elements throughout. Well-known functions or constructions will not necessarily be described in detail for brevity and/or clarity.

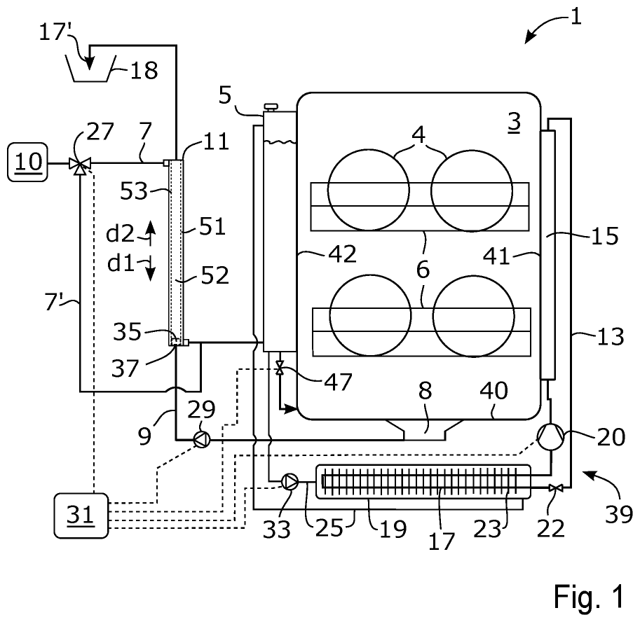

FIG. 1 schematically illustrates a washing appliance 1, according to some embodiments.

According to the illustrated embodiments, the washing appliance 1 is a dishwasher. According to further embodiments, the washing appliance 1 as referred to herein may be another type of washing appliance 1, such as a washing machine, or the like. The washing appliance 1 comprises a washing compartment 3 configured to accommodate items 4 to be washed. According to the illustrated embodiments, the washing appliance 1 comprises racks 6 configured to hold the items 4 in the washing compartment 3. The washing appliance 1 further comprises a sump 8 at a bottom 39 of the washing appliance 1. Moreover, the washing appliance 1 comprises a door arranged to provide a closure to the washing compartment 3, one or more spray devices, such as one or more spray arms, and a circulation pump. The circulation pump is configured to pump liquid from the sump 8 to the spray devices during a wash cycle of the washing appliance 1. The liquid is sprayed from the spray devices onto the items 4 to clean the items 4. Due to gravity, the liquid is collected in the sump 8 where it is pumped again by the circulation pump to the spray devices. For the reason of brevity and clarity, the door, the spray devices, and the circulation pump are not illustrated in FIG. 1.

The washing appliance 1 comprises a water inlet tank 5 configured to accommodate water for use in a wash cycle in the washing compartment 3. The washing appliance 1 comprises a water inlet conduit 7 configured to supply water to the water inlet tank 5. The water inlet tank 5 is arranged in heat exchanging contact with a wall 42 of the washing compartment 3. According to the illustrated embodiments, the water inlet conduit 7 is connected to a water supply network 10. The washing appliance 1 further comprises a drainconduit 9 configured to conduct washing liquid from the washing compartment 3.

Furthermore, the washing appliance 1 comprises a drain pump 29 configured to pump washing liquid from the washing compartment 3 via the drain conduit 9. The drain pump 29 comprises an inlet and an outlet. The inlet of the drain pump 29 is fluidly connected to the sump 8. The drain conduit 9 is fluidly connected to the outlet of the drain pump 29. An outlet 17′ of the drain conduit 9 is connected to a drain 18. The drain pump 29 is thus configured to pump liquid from the sump 8, through the drain conduit 9, to the drain 18. As is further explained herein, the drain pump 29 may comprise a pump unit and an electric motor configured to power the pump unit. The pump unit and the electric motor are not illustrated in FIG. 1 for the reason of brevity and clarity. The washing appliance 1 further comprises a heat exchanger 11. The heat exchanger 11 is configured to exchange heat between the drain conduit 9 and the water inlet conduit 7. In this manner, heat of liquid in the drain conduit 9 can be transferred to water in the water inlet conduit 7 in a simple and efficient manner, to thereby improve the energy efficiency of the washing appliance 1, as is further explained herein.

The washing appliance 1 comprises a heat pump circuit 13 comprising a condenser 15 and an evaporator 17. Moreover, the heat pump circuit 13 comprises an expansion valve 22 upstream of the evaporator 17 and a compressor 20 configured to pump working media, such as a refrigerant, through the heat pump circuit 13. The condenser 15 is configured to heat the washing compartment 3. According to the illustrated embodiments, the condenser 15 is arranged in heat exchanging contact with a wall 41 of the washing compartment 3. In this manner, washing liquid sprayed onto the wall 41 will be heated by the condenser 15. The condenser 15 may be a pillow heat exchanger or roll bond.

According to the illustrated embodiments, the washing appliance 1 comprises a media container 19. The evaporator 17 is configured to cool a media in the media container 19. As is further explained herein, according to the illustrated embodiments, the media comprises water originating from the water inlet tank 5. The evaporator 17 may be configured to cool the media in the media container 19 such that the media changes phase from liquid to solid, i.e. into ice. As can be seen in FIG. 1, according to the illustrated embodiments, the evaporator 17 comprises fins 23 extending into the media container 19. In this manner, the heat transferring capacity between the media in the media container 19 and working fluid of the heat pump circuit 13 is significantly increased. Moreover, a more uniform ice production is provided in the media container 19. The compressor 20, the evaporator 17, and the media container 19 may be arranged at the bottom 39 of the washing appliance 1, i.e. below a bottom wall 40 of the washing compartment 3.

Furthermore, as can be seen in FIG. 1, according to the present disclosure, the heat exchanger 11 and the water inlet tank 5 are separate units. This provides several advantages, as is further explained herein. According to the illustrated embodiments, the water inlet tank 5 is arranged adjacent to a vertical wall 42 of the washing compartment 3. The heat exchanger 11 may be arranged at the bottom 39 of the washing appliance 1, i.e. below a bottom wall 40 of the washing compartment 3. A volume of the water inlet tank 5 may for example be within the range of 2-6 litres, such as within the range of 3.2-4 litres.

According to the illustrated embodiments, the heat exchanger 11 comprises a first passage 51 configured to conduct water flowing through the water inlet conduit 7 and a second passage 52 configured to conduct liquid flowing through the drain conduit 9. Thus, according to the illustrated embodiments, the first passage 51 can be said to form a portion of the water inlet conduit 7 and the second passage 52 can be said to form a portion of the drain conduit 9. Furthermore, according to the illustrated embodiments, the water inlet conduit 7 comprises a bypass conduit 7′, bypassing the first passage 51. Moreover, the washing appliance 1 comprises an inlet valve 27 configured to control flow of water in the water inlet conduit 7. According to the illustrated embodiments, the inlet valve 27 is a three-way valve fluidly connected to the water supply network 10, to the water inlet conduit 7 and to the bypass conduit 7′. The inlet valve 27 is controllable between a closed position and a first and a second open position. In the closed position, the inlet valve 27 closes a fluid connection between the water supply network 10 and the water inlet conduit 7 and the bypass conduit 7′. In the first open position, a fluid connection is open between the water supply network 10 and the water inlet conduit 7 and a fluid connection is closed between the water supply network 10 and the bypass conduit 7′. In the second open position, the fluid connection is open between the water supply network 10 and the bypass conduit 7′. Moreover, in the second open position, a fluid connection between the water supply network 10 and the first passage 51 of the heat exchanger 11 may be closed.

The washing appliance 1 further comprises a control arrangement 31 configured to selectively control the opening state of the inlet valve 27 based on an operational state of the drain pump 29. For example, at the end of a wash cycle, when the sump 8 is to be emptied, and the drain pump 29 is operating, the control arrangement 2 may control the inlet valve 27 to the first open position such that water flows from the water supply network 10 towards the water inlet tank 5 via the water inlet conduit 7. In this manner, heat of the liquid in the drain conduit 9 is transferred to water in the water inlet conduit 7 and the heat can be utilized in a subsequent wash cycle in the washing compartment 3. At other occasions, when no heat is wanted in the incoming water to the water inlet tank 5, the control arrangement 31 may control the opening state of the inlet valve 27 to the second opening state. In this manner, the cold water from the water supply network 10 is flowing through the bypass line 7′ to the water inlet tank 5, i.e. past the heat exchanger 11. Occasions when no heat is wanted in the incoming water to the water inlet tank 5 may for example comprise a rinse cycle, a quick cycle, a softener regeneration cycle, a drying cycle, or the like.

The control arrangement 31 may be configured to estimate a flow rate of liquid flowing through the drain conduit 9 and control the opening state of the inlet valve 27 based on the estimated flow rate of liquid flowing through the drain conduit 9. In this manner, the heat transfer from liquid in the drain conduit 9 to water in the water inlet conduit 7 can be further optimized. The control arrangement 31 may be configured to estimate the flow rate of liquid flowing through the drain conduit 9 by monitoring the torque of the drain pump 29. Thereby, the flow rate of liquid flowing through the drain conduit 9 is estimated in a simple and efficient manner without the need for additional sensors. The control arrangement 31 may monitor the torque of the drain pump 29 by monitoring electrical quantities, such as current and voltage, of an electric motor of the drain pump 29. The flow rate of liquid flowing through the drain conduit 9 significantly affects the torque of the drain pump and the electrical quantities of the electric motor of the drain pump 29. For example, if the flow rate of liquid flowing through the drain conduit 9 is high, the torque of the drain pump 29 is high. Contrarywise, if the flow rate of liquid flowing through the drain conduit 9 is low, and/or if the drain pump 29 is sucking air, the torque of the drain pump 29 is low.

According to the illustrated embodiments, the control arrangement 31 is configured to open the inlet valve 27 such that water is flowing through the inlet water conduit 9, i.e. control the inlet valve 27 to the first open position, when it is estimated that liquid is flowing through the drain conduit 9, and/or when it is estimated that liquid recently has flowed through the drain conduit 9. In this manner, the heat transfer from liquid in the drain conduit 9 to water in the water inlet conduit 7 is further optimized. Moreover, according to the illustrated embodiments, the control arrangement 31 is further configured to control operation of the drain pump 29. That is, according to the illustrated embodiments, the control arrangement 31 is configured to perform a simultaneous control of the opening state of the inlet valve 27 and the operation of the drain pump 29. In this manner, the heat transfer from liquid in the drain conduit 9 to water in the water inlet conduit 7 can be further optimized. The washing appliance 1 may comprise a flow meter at the water inlet conduit 7. According to such embodiments, the control arrangement 31 may control the opening state of the inlet valve 27 so as to obtain a wanted flowrate of water through the water inlet conduit 7, and/or so as to obtain a wanted fill level of the water inlet tank 5, using data of the flow meter.

In addition, according to embodiments of the present disclosure, the control arrangement 31 is configured to control the drain pump 29 to operate in cycles during an emptying process of the sump 8. The cycles may comprise operation intervals and standstill intervals between the operation intervals. Due to these features, the energy efficiency of the washing appliance 1 is further improved because more time is available for heat transfer from liquid in the drain conduit 9 to water in the water inlet conduit 7. In addition, the pulsation of the liquid in the drain conduit 9 may contribute to a turbulent flow in the second passage 52 of the heat exchanger 11 which increases heat transfer to water in the first passage 51 of the heat exchanger 11. A length of the standstill intervals is within the range of 0.5 seconds to 7 seconds, such as within the range of 1 second to 3 seconds. A length of the operation intervals is within the range of 0.5 seconds to 3 seconds, such as within the range of 0.7 seconds to 1.5 seconds.

According to the illustrated embodiments, the heat exchanger 11 comprises a wall 53 separating the first and second passages 51, 52. According to some embodiments, the wall 53 is corrugated. Thereby, the heat transfer from liquid in the drain conduit 9 to water in the water inlet conduit 7 is further improved. Furthermore, according to the illustrated embodiments, the heat exchanger 11 comprises a vortex generator 35 at an inlet 37 of the second passage 52. As a result, the heat transfer from liquid in the drain conduit 9 to water in the water inlet conduit 7 is further improved because the vortex generator 35 generates a vortex in the liquid flowing into the second passage 52 which may last through a significant portion of the second passage 52. The vortex generator 35 may comprise one or more blades extending into the second passage 52. The wall 53 separating the first and second passages 51, 52, as well as other delimiting walls of the first and second passages 51, 52, may be formed by stainless steel. The thickness of the wall 53 separating the first and second passages 51, 52 may for example be within the range of 0.7-3.5 mm, such as within the range of 1-2 mm. The length of the heat exchanger 11, i.e. the length of the respective first and second passages 51, 52 in the respective flow direction thereof, may be within the range of 1-3 meters, such as within the range of 1.5-2meters. The heat exchanger 11 may not be straight, as is the case according to the schematic illustration of FIG. 1, but may be curved, for example around the sump 8. The diameter of the second passage 52 of the heat exchanger 11 may be within the range of 10-21 mm, such as within the range of 14-18 mm. The outer diameter of the heat exchanger 11 may be within the range of 23 -40 mm, such as within the range of 25-35 mm.

Furthermore, according to the illustrated embodiments, the first passage 51 is arranged to conduct water in a first flow direction dl and the second passage 52 is arranged to conduct liquid in a second flow direction d2, and wherein the second flow direction d2 is opposite to the first flow direction dl. Thereby, the energy efficiency of the washing appliance 1 is further improved because the heat transfer from liquid in the drain conduit 9 to water in the water inlet conduit 7 is further improved. Moreover, the first and second passages 51, 52 are coaxially arranged, wherein the first passage 51 is coaxially arranged around the second passage 52. Thereby, heat can be transferred from liquid in the drain conduit 9 to water in the water inlet conduit 7 in an efficient manner, while the risk for clogging in the second passage 52 is kept low, for example with particles in the drain liquid in the second passage 52. Furthermore, due to these features, a compact heat exchanger 11 is provided. As a result, the heat exchanger 11 has a low impact on the space available for other components of the washing appliance 1, such as the washing compartment 3 of the washing appliance 1.

According to the illustrated embodiments, the heat exchanger 11 is arranged at the bottom 39 of the washing appliance 1. In that way, the space available in the washing appliance is utilized in an efficient manner. Moreover, a short distance is provided between the outlet of the drain pump 29 and the inlet 37 of the second passage 52 of the heat exchanger 11. In this manner, a short conduit can be arranged between the outlet of the drain pump 29 and the inlet 37 of the second passage 52, which reduces heat loss of liquid flowing from the drain pump 29 to the heat exchanger 11, which ensures an efficient heat transfer in the heat exchanger 11.

According to the illustrated embodiments, the washing appliance 1 comprises a circulation circuit 25 configured to circulate water from the water inlet tank 5 through the media container 19. The circulation circuit 25 comprises a circulation pump 33. The control arrangement 31 is configured to activate the circulation pump 33 in a drying phase of the washing appliance 1. In this manner, the water from the water inlet tank 5 is used to melt the ice in the media container 19 and a colder water is provided in the water inlet tank 5. Due to the heat exchanging contact between the water inlet tank 5 and the wall 42 of the washing compartment 3, the cold water in the water inlet tank 5 cools the wall 42 of the washing compartment 3. As a result, an improved drying performance is provided in an energy efficient manner and less time is thereby required for the drying phase. This because the cold wall 42 of the washing compartment 3 improves and accelerates the condensation process of water on the wall 42 of the washing compartment 3.

The control arrangement 31 may be connected to components of the washing appliance 1 as depicted in FIG. 1, as well as to further components of the washing appliance 1 than depicted in FIG. 1. Examples of such components are a circulation pump, a valve 47 arranged to control flow of water from the water inlet tank 5 to the washing compartment 3, the compressor 20 of the heat pump circuit 13, the circulation pump 33 of the circulation circuit 25, the inlet valve 27, the drain pump 29, a sensor arranged to detect an opening state of a door of the washing appliance, a user interface of the washing appliance, one or more flow sensors, and/or one or more pressure sensors.

The control arrangement 31 may comprise a calculation unit which may take the form of substantially any suitable type of processor circuit or microcomputer, e.g. a circuit for digital signal processing (digital signal processor, DSP), a Central Processing Unit (CPU), a processing unit, a processing circuit, a processor, a microprocessor, or other processing logic that may interpret and execute instructions. The herein utilised expression “calculation unit” may represent a processing circuitry comprising a plurality of processing circuits, such as, e.g., any, some or all of the ones mentioned above.

The control arrangement 31 may further comprise a memory unit, wherein the calculation unit may be connected to the memory unit, which may provide the calculation unit with, for example, stored program code and/or stored data which the calculation unit may need to enable it to do calculations. The calculation unit may also be adapted to store partial or final results of calculations in the memory unit. The memory unit may comprise a physical device utilised to store data or programs, i.e., sequences of instructions, on a temporary or permanent basis. According to some embodiments, the memory unit may comprise integrated circuits comprising silicon-based transistors. The memory unit may comprise e.g. a memory card, a flash memory, or another similar volatile or non-volatile storage unit for storing data.

The control arrangement 31 is connected to components of the washing appliance 1 for receiving and/or sending input and output signals. These input and output signals may comprise waveforms, pulses, or other attributes which the input signal receiving devices can detect as information and which can be converted to signals processable by the control arrangement 31. These signals may then be supplied to the calculation unit.

In the embodiments illustrated, the washing appliance 1 comprises a control arrangement 31 but might alternatively be implemented wholly or partly in two or more control

It is to be understood that the foregoing is illustrative of various example embodiments and that the invention is defined only by the appended claims. A person skilled in the art will realize that the example embodiments may be modified, and that different features of the example embodiments may be combined to create embodiments other than those described herein, without departing from the scope of the present invention, as defined by the appended claims.

As mentioned, according to the illustrated embodiments, the washing appliance 1 is a dishwasher. Therefore, throughout this disclosure, the wording “washing appliance” may be replaced by the wording “dishwasher”.

As used herein, the term “comprising” or “comprises” is open-ended, and includes one or more stated features, elements, steps, components, or functions but does not preclude the presence or addition of one or more other features, elements, steps, components, functions, or groups thereof.

1. A washing appliance comprising:
a washing compartment,
a water inlet tank configured to accommodate water for use in a wash cycle in the washing compartment,
a water inlet conduit configured to supply water to the water inlet tank,
a train conduit configured to conduct washing liquid from the washing compartment,
a heat exchanger configured to exchange heat between the drain conduit and the water inlet conduit, and
a heat pump circuit comprising a condenser and an evaporator, wherein the condenser is configured to heat the washing compartment.

2. The washing appliance according to claim 1, wherein the washing appliance comprises a media container, and wherein the evaporator is configured to cool a media in the media container.

3. The washing appliance according to claim 2, wherein the evaporator is configured to cool the media in the media container such that the media changes phase from liquid to solid.

4. The washing appliance according to claim 2, wherein the evaporator comprises fins extending into the media container.

5. The washing appliance according to claim 2, wherein the media comprises water.

6. The washing appliance according to claim 2, wherein the washing appliance further comprises a circulation circuit configured to circulate water from the water inlet tank through the media container.

7. The washing appliance according to claim 1, wherein the washing appliance comprises an inlet valve configured to control flow of water in the water inlet conduit and a drain pump configured to pump washing liquid from the washing compartment via the drain conduit, and wherein the washing appliance comprises a control arrangement configured to selectively control an opening state of the inlet valve based on an operational state of the drain pump.

8. The washing appliance according to claim 7, wherein the control arrangement is further configured to control operation of the drain pump.

9. The washing appliance according to claim 8, wherein the control arrangement is configured to control the drain pump to operate in cycles.

10. The washing appliance according to claim 1, wherein the condenser is arranged in heat exchanging contact with a wall of the washing compartment.

11. The washing appliance according to claim 6, wherein the circulation circuit comprises a circulation pump fluidly connected to the circulation circuit, and wherein the washing appliance comprises a control arrangement configured to activate the circulation pump in a drying phase of the washing appliance.

12. The washing appliance according to claim 1, wherein the water inlet tank is arranged in heat exchanging contact with a wall of the washing compartment.

13. The washing appliance according to claim 1, wherein the heat exchanger comprises a first passage configured to conduct water flowing through the water inlet conduit and a second passage configured to conduct liquid flowing through the drain conduit.

14. The washing appliance according to claim 13, wherein the first and second passages are coaxially arranged.

15. The washing appliance according to claim 1, wherein the washing appliance is a dishwasher.
